(19) United States
(12) Patent Application Publication
(10) Pub. No.: US 2015/0245593 A1
(43) Pub. Date: Sep. 3, 2015

(54) AUTONOMOUS MOTION DEVICE, SYSTEM, AND METHOD

(71) Applicants: JASON E. O'MARA, PORTLAND, OR (US); TARA S.P. O'MARA, PORTLAND, OR (US)

(72) Inventors: JASON E. O'MARA, PORTLAND, OR (US); TARA S.P. O'MARA, PORTLAND, OR (US)

(21) Appl. No.: 14/636,545

(22) Filed: Mar. 3, 2015

Related U.S. Application Data
(60) Provisional application No. 61/947,129, filed on Mar. 3, 2014.

(51) Int. Cl. A01K 15/02; A63H 29/22; A01K 29/00

(52) U.S. Cl. CPC A01K 15/025; A01K 29/005; A63H 29/22

(57) ABSTRACT

An article, forming a toy for a pet or child, includes an enclosure defining a three-dimensional body having an ovoid or spherical shape, an electric motor including a motor body held in place by the enclosure and a drive shaft, and an offset mass element disposed within the enclosure and mechanically coupled with the drive shaft of the electric motor. The article further includes an angular position sensor, an accelerometer sensor, and a control system configured to vary electrical power supplied to the electric motor to drive the drive shaft based, at least in part, on the measurements of angular position of the offset mass element and the angular position of the enclosure to generate rolling motion of the enclosure relative to a surface upon which the enclosure rests.

### CROSS REFERENCE TO RELATED APPLICATIONS

This application is a non-provisional of and claims priority to U.S. provisional application Ser. No. 61/947,129, filed Mar. 3, 2014, titled INTERACTIVE TOY FOR DOMESTIC PET, the entirety of which is hereby incorporated herein by reference.

### BACKGROUND

Pet toys and toys for children seek to entertain and encourage interaction of the pet or child. Some toys utilize integrated electronics to increase entertainment and interaction. Electronic toys of various forms provide a variety of motion and audio/visual stimuli to pets and children.

### SUMMARY

In an aspect of the present disclosure, an article includes an enclosure defining a three-dimensional body having an ovoid or spherical shape and an electric motor disposed within the enclosure. The article may take the form of a pet toy or a children's toy. The electric motor includes a motor body held in place by the enclosure and a drive shaft. An offset mass element is disposed within the enclosure and mechanically coupled with the drive shaft of the electric motor. An angular position sensor is disposed within the enclosure to measure an angular position of the offset mass element relative to the enclosure. An accelerometer sensor is disposed within the enclosure to measure an angular position of the enclosure relative to a gravity vector.

A control system is disposed within the enclosure that is configured to receive measurements of the angular position of the offset mass element relative to the enclosure from the angular position sensor, and to receive measurements of the angular position of the enclosure relative to the gravity vector. The control system is further configured to vary electrical power supplied to the electric motor to drive the drive shaft based, at least in part, on the measurements of angular position of the offset mass element and the angular position of the enclosure to generate rolling motion of the enclosure relative to a surface upon which the enclosure rests.

Claimed subject matter, however, is not limited by this summary as additional information is disclosed by the following written description and associated drawings.

### BRIEF DESCRIPTION OF DRAWINGS

FIG. 1 shows a schematic representation of an article disclosed herein.

FIG. 2A shows an exploded view of an example embodiment of an article disclosed herein.

FIG. 2B shows a first lateral view of an example embodiment of an assembled article disclosed herein.

FIG. 2C shows a second lateral view of an example embodiment of an assembled article disclosed herein.

FIG. 3 shows a flowchart of an example method performed by a control system for controlling motion.

FIG. 4 shows a flowchart of an example method performed by a control system for controlling direction of motion.

FIG. 5 illustrates a system for communication with an article as disclosed herein.

FIG. 6 illustrates a method performed by a computing system for suggesting a control module and/or mode.

### DETAILED DESCRIPTION

Many toys rely heavily on engagement from a caretaker. For example, many child toys and pet toys (e.g., tug-of-war toys, feathers-on-strings, crinkly baby toys, toddler figuring toys) require a human to use the toy in order to engage, stimulate, and exercise the child or pet. An article and method for operating the article are disclosed herein that reduces the burden on the caretaker by offering autonomous and unpredictable motion by a surprisingly simple configuration. This device offers the distinct advantage of promoting child and pet play and fitness while the caretaker is away or when the caretaker is unable or unwilling to play. A system and method for automatically recommending new play modes and/or settings based on activity with the toy are further disclosed herein.

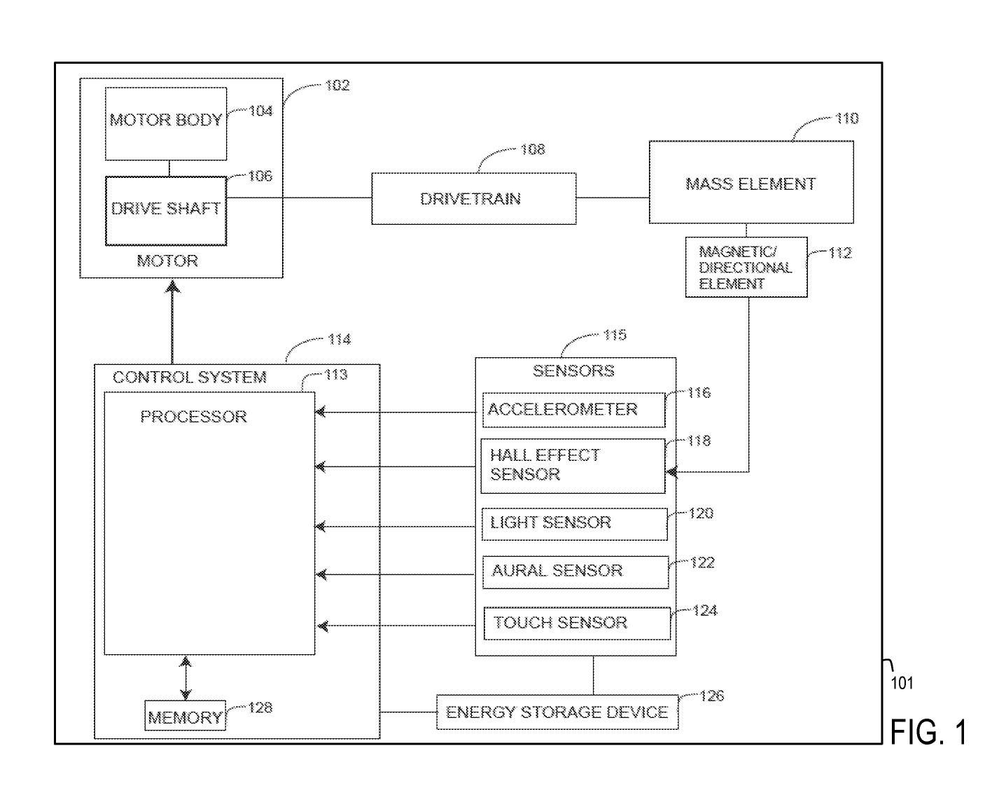

FIG. 1 shows a schematic representation of an article 101. The article may take the form of a pet toy or a children's toy. Article 101 includes a motor 102 which may include a motor body 104 and a drive shaft 106. The motor body may be mechanically coupled to the drive shaft so as to induce a motion of the drive shaft. The motor 102 may be mechanically coupled to a drivetrain 108, which may be coupled to a mass element 110, such as an offset mass element. An offset mass element can induce a motion (e.g., rotation) of the article. In one example, the actuation of the motor can effect a forward or backward rotation of the offset mass element, causing a center of gravity of the article to change, thereby inducing motion of the article (e.g., linear or near-linear motion of an enclosure of the article relative to a surface by rolling).

The offset mass element 110 may include or may be mechanically coupled to a magnetic and/or directional element 112. In one example, a magnetic element is press-fit to the offset mass element such that a 1:1 relationship between the offset mass element and the magnetic element is achieved.

The article may also include a control system 114 that can communicate with one or more of the motor 102, the offset mass element 110, and one or more sensors 115. In an example, control system 114 may include one or more logic devices such as examples processor devices 113 (i.e., processors) or other suitable logic devices. The one or more processors may also be microcontrollers, computing elements, etc.

In at least some implementations, the control system may take the form of a computing device having one or more logic devices (e.g., processor devices) forming a logic subsystem and one or more information storage devices forming a storage subsystem having instructions stored thereon executable by the logic subsystem to perform the methods or operations disclosed herein. Such information storage devices include non-transitory information storage devices that hold executable instructions in non-transitory form, and may include one or more magnetic memory devices, flash memory devices, etc. Executable instructions may include software and/or firmware, as non-limiting examples.

Control system 114 may be operatively and communicatively coupled to and receive signals from one or more sensors 115, such as an accelerometer 116, a Hall effect sensor 118, a light sensor 120, an aural sensor 122, a touch sensor 124. The article 101 may include more than one of each of said sensors. It may be understood that the article may contain said sensors and said sensors may be coupled to the one or more processors.

The control system 114 may be mechanically coupled to an energy storage device 126 and may draw power as needed from said energy storage device. In one example, if the article is powered on and in a play state, the control system 114 is drawing power from the energy storage device 126. The energy storage device 126 may be coupled to the one or more sensors 115 to power the sensors. In one example, the energy storage device 126 is a rechargeable battery such as a lithium ion battery.

The one or more processors 113 may be configured to receive one or more signals from the one or more sensors 115. For example, the processor may be configured to receive an acceleration signal from one or more accelerometers 116, a magnetic signal from the Hall effect sensor 118, a light intensity signal from the light sensor 120 (e.g., optical sensor), an aural frequency or intensity sensor from the aural sensor 122, and/or a capacitive signal from the touch sensor 124.

For example, the Hall effect sensor 118 can receive a magnetic field output or signal from the magnetic element, said Hall effect sensor can send a signal to the control system 114, and the control system 114 can output an electrical power to the motor 102 responsive to receiving said signal.

The control system 114 may include an amount of memory 128 (e.g., random-access memory) and/or other various components known to those skilled in the art for the purpose of computing, controlling, and/or displaying.

The control system 114 may be programmed with instructions executable by a logic device of the control system. For example, the control system may be a computing device including a data storage subsystem holding instructions executable by a logic subsystem. In another example, the control system may include traditional hard-coded circuitry.

While the use of a magnetic element has been described for determining an angular position of a mass element, the use of one, two, or more accelerometers for determining a position of an offset mass element may be used in the place of the magnetic element.

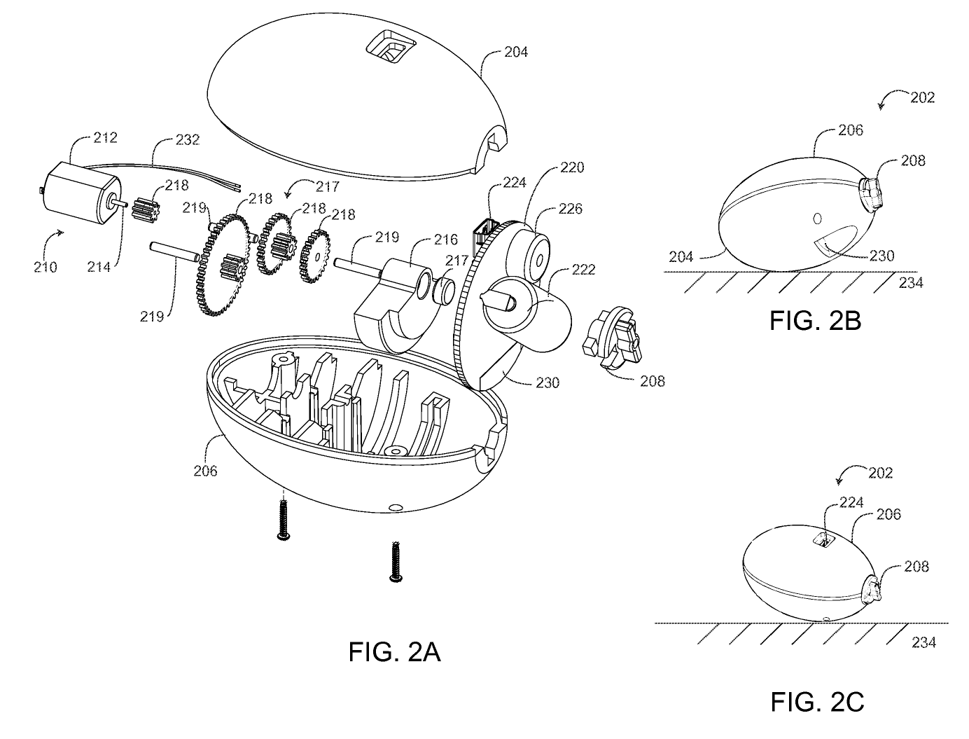

One example embodiment of the article 101 disclosed herein is illustrated in FIG. 2A, FIG. 2B, and FIG. 2C. FIG. 2A shows a lateral, exploded view of the article, FIG. 2B shows a lateral view of the assembled enclosure 202 from a first angle, and FIG. 2C shows a lateral view of the assembled enclosure 202 from a different angle. The enclosure 202 defines a three-dimensional body having an ovoid or spherical shape. An ovoid or a spherical shape offers the advantage of rolling in an unpredictable manner on a surface, made further unpredictable by the presence of any obstacles or inhomogeneous features of a surface upon which the enclosure rests and/or moves. In one example, the article is a children's toy or a pet toy, and the volume of the article is about 51 cubic centimeters.

In this example, the enclosure includes three pieces: a top portion 204, a bottom portion 206, and a plug portion 208. The plug portion 208 may include various accessories (e.g., tail feather, leather, rubber, mouse) and may be removable and/or interchangeable by a caretaker.

The article includes an electric motor 210 disposed within the enclosure, the electric motor including a motor body 212 held in place by the enclosure (or otherwise supported by and affixed to the enclosure) and a drive shaft 214. In another example, the motor body may otherwise be coupled to the enclosure (e.g., by adhesive, friction, etc.). In an example, drive shaft 214 rotates relative to motor body 212.

The article further includes an offset mass element 216 disposed within the enclosure and mechanically coupled with the drive shaft of the electric motor 210 via a drivetrain 217. However, a drivetrain may be omitted in some implementations. The drivetrain may include one or more pins and one or more gears coupled together to increase or adjust a torque. In one example, the drivetrain increases the torque of the motor by 50 times, such that, for example, a 10 g/cm motor can effectively produce 500 g/cm via the drivetrain. In this exemplary embodiment, the drivetrain 217 includes four gears 218 and three pins 219, where the drive shaft 214 is coupled to a first gear, the first gear is coupled to a first pin, the first pin is coupled to a second gear, the second gear is coupled to a second pin, the second pin is coupled to a third gear, the third gear is coupled to a fourth gear, the fourth gear is coupled to a third pin, the third pin is coupled (e.g., press fit, screwed, etc.) to the offset mass element 216.

In one example, the offset mass element 216 may be comprised of a material having sufficient density, mass, and/or size for inducing motion of the enclosure. The material may include a brass alloy, steel, and/or plastic with embedded dense (e.g., metal) parts. In this embodiment, the offset mass element 216 includes a magnetic element 221 (e.g., the magnetic element is press-fit to the offset mass element 216). In other embodiments, the magnetic element may be otherwise mechanically coupled to the offset mass element (e.g., glued to a surface of the offset mass element).

The article further includes an angular position sensor disposed within the enclosure to measure an angular position of the offset mass element 216 relative to the enclosure. In one example, said angular position sensor is a Hall effect sensor capable of receiving a polarity signal from the magnetic element 221 and said angular position sensor is coupled to a printed circuit board 220.

The article further includes an accelerometer sensor coupled to the printed circuit board 220 disposed within the enclosure for measuring an angular position of the enclosure relative to a gravity vector.

The article also includes a speaker 226 for emitting sound.

The article also includes an energy storage device, such as a battery 222 which is coupled to said printed circuit board 220. In this embodiment, the article includes a charging port 224 coupled to said battery 222. The charging port may be exposed through a hole in the top portion 204 of the enclosure so that the article can be charged (e.g., using a charging cable). In another example, the battery 222 may be charged through inductive charging. The battery 222 may be coupled to the motor 210 via one or more wires 232 or via a wireless mechanism.

The printed circuit board 220 may also include a touch sensor 230 accessible from an assembled enclosure. The touch sensor 230 may be exposed on the exterior of the article (as shown in FIG. 2B) such that a user can change the article's state via touch. In one example, the user can power the article on and off via a touch to the touch sensor for a first prescribed interval (e.g., less than 5 seconds). The touch sensor may also enable the user to enter a programming or firmware update state by touching the touch sensor for a second prescribed interval (e.g., 5 seconds or longer, 10 or more seconds).

The article includes a control system disposed within the enclosure. In this embodiment, the control system can be partially or wholly mounted and/or coupled to the printed circuit board 220.

The control system may be configured or programmed to receive a measurement of the angular position of the offset mass element 216 relative to the enclosure 202 from the angular position sensor and may also be configured to receive a measurement of the angular position of the enclosure 202 relative to the gravity vector. The control system may also be configured to vary electrical power supplied to the electric motor 210 to drive the drive shaft 214 based, at least in part, on the measurements of angular position of the offset mass element 216 and the angular position of the enclosure 202. By varying the electrical power supplied to the electric motor 210 based on one or more sensor inputs, the control system is able to generate a motion (e.g., rolling, spinning) of the enclosure 202 relative to a surface 234 upon which the enclosure rests. Furthermore, the control system is able to change a speed and/or direction of a rolling motion by varying the electrical power supplied to the electric motor based on one or more sensor inputs.

For example, the control system may compare the angular position of the offset mass element 216 (e.g., obtained at a Hall effect sensor) to the angular position of the enclosure 202 (e.g., obtained by an accelerometer) to obtain an angular position difference. The control system may vary the electrical power supplied to the electrical motor 210 responsive to the angular position difference.

In one example, the control system may vary the electrical power in order to maintain a target angular position difference. The target angular position difference in said example may correspond to a rolling motion of the enclosure relative to the surface 234 in a first direction (e.g., forward, sideways, backward). The control system may further be configured to vary the electrical power supplied to the electric motor 210 responsive to a second angular position difference to maintain a second target angular position corresponding to rolling motion of the enclosure 202 relative to the surface 234 in a second direction (e.g., opposite the first direction).

The control system may be electrically coupled to the motor 210 by one or more coupling elements 232 (e.g., stranded wire, connectors).

The control system may be configured to adjust a speed of the electric motor drive shaft 214 (e.g., by varying the voltage output to the motor). In one example, the speed of the motor may be adjusted responsive to a signal received from one or more sensors indicating an obstacle has been detected on the surface upon which the enclosure rests. As a specific example, an accelerometer may detect a change in velocity (e.g., a change from positive velocity to a zero or zero-velocity), and said control system may change the speed of the electric motor drive shaft 214 responsive to detecting said change in velocity.

The control system may be configured to adjust a direction of the electric motor drive shaft at a prescribed interval, and/or in response to receiving a signal indicating an obstacle has been detected in the article's environment. For example, the control system may be configured to reverse the direction of the electric drive shaft from a first direction to a second direction in response to detecting a near-zero velocity (e.g., when the article hits a wall, when the article hits an animal). The control system may be configured to continuously oscillate the output to the electric motor for a period of time in response to receiving a signal from a sensor. For example, when the article is trapped, the control system may output an oscillating voltage output to the motor such that the article rocks back and forth or such that the article can attempt to move out of a trap or blocked environment.

In another example, the control system may be configured to adjust a speed or direction of the motor drive shaft 214 based on an operation mode that a user has selected for the article. For example, the article may be operable in a “frisky” mode wherein the control system is configured to change a speed and/or change a direction frequently (e.g., every 10 seconds). In another example, the article may be operable in a “sneaky” mode wherein the control system is configured to change the speed and/or direction of the motor drive shaft slowly and/or less frequently than the “frisky” mode.

The control system may implement one or more control modules which respectively may include one or more operation modes. One or more control modules may be transferred, uploaded, or downloaded to the control system. As one example, an introductory module can contain at least three operation modes: a frisky mode, a sneaky mode, a scaredy mode.

The frisky mode may include instructions for continuous play, where the article is moving for a large majority of the time. In the frisky mode, the article attempts to avoid obstacles by reversing directions upon detecting an obstacle and/or by stopping motion (e.g., “playing dead”). In one case, a determination to “play dead” for a period of time is made based on whether the device has been trapped (e.g., by a child, animal, or other obstacle). When the article enters a “play dead” state, the article may output a “play dead” sound or motion pattern to indicate it is entering “play dead state”, and then cease motion and sound for a period of time (e.g., 10 seconds). After a “play dead state” period, the article may initiate motion and/or sound again in the frisky mode.

The sneaky mode may include instructions for moving the article for a period of time (e.g., 30 seconds), stopping the motion for a period of time (e.g., 5 seconds), and moving the device again. In the sneaky mode, if an obstacle is detected, the control system may stop motion of the article for a period of time (e.g., 5 seconds) and then may attempt to reverse motion direction. Upon determining the article is trapped and/or has reached an obstacle, the article plays dead for a period of time (e.g., 5-10 seconds). The sneaky mode may include less motion and/or slower motion than the frisky mode. In the sneaky mode, the device may try to avoid being trapped.

The scaredy mode may include instructions executable by the control system for moving the article for a short period of time (e.g., 5-10 seconds), waiting for a wait period (e.g., up to 15 seconds), and moving the article for a second period of time. The control system may include instructions for the article to attempt to avoid obstacles and/or to determine to enter the play dead state in a similar manner as in other modes. When the article is a toy, the scaredy mode may be a first recommended mode for introducing the toy for play to, for example, a child or pet. Scaredy mode may be recommended for timid children and/or pets.

In a given operation mode, the device may detect when an animal or child is around and/or when an animal or child is playing with the device. The detection may include receiving a signal from one or more sensors. The play mode may be configured to respond to the signal in order to stimulate the animal. In a specific example, the device may move in a direction away from the animal upon detecting the animal is within a threshold distance (e.g., 1 foot). In another example, the device may move in the direction away from the animal upon detecting the animal is moving toward the device. This helps to stimulate the animal by responding to the animal's motion, enabling a game of “chase”, engaging the animal's instincts. Furthermore, the autonomous motion described herein (which may not require input or direct play from the animal in order to induce device motion) offers the advantage of enticing the animal before the animal thinks to play. Additionally the autonomous motion in combination with an ovoid shape offers unpredictable motion, which is attractive to an animal.

The article may include one or more ambient condition sensors (e.g., optical sensor, microphone) to detect ambient conditions (e.g., light, sound). In response to detecting a threshold signal from the one or more ambient condition sensors, the control system may be configured to change a mode of the article or to vary an electrical voltage output to the electric motor. For example, if a threshold signal is detected from an optical sensor, this may indicate that an animal is nearby, and the control system may exit a rest state and enter a play state, or may exit a first mode and enter a frisky mode, described in more detail below.

In a given mode and/or across modes, various states may be possible for the device. For example, a play state, rest state, trapped state, and/or play dead state may be possible. The device may enter and exit said states at predetermined intervals and/or at random intervals.

In one example, the device may enter the play state (e.g., after being powered on) and move and make sound for 5 minutes. After the 5 minutes, the device may enter a rest state for 55 minutes of no motion and/or sound. After the 55 minutes, the device may re-enter the play state and move and make sounds again for 5 minutes. These steps may be repeated for a predetermined number of hours. This offers the advantage of stimulating a pet or child while a caretaker is unavailable to turn the device on and off. It may be understood that this is an example and other configurations and/or time periods are possible. It may be further appreciated that the device may exit the rest state and enter the play state in response to a stimulus (e.g., light signal, motion signal).

In another example, if a particular frequency of sound (e.g., hand clapping) is detected by one or more microphones, the control system may be configured to “wake up” the article, changing the state from a rest state to a play state. This offers the advantage of being able to find the article if the article has become lost or trapped. For example, a caretaker may not be able to find a toy because a child or pet has hidden the toy; here, the caretaker can clap his/her hand so that the toy can respond, enabling location of the device.

In a given operation mode, various settings may be allowed. Some example settings include a total play duration (e.g., 2, 4, or 8 hours), a play duration per hour (e.g., 5, 10, or 15 minutes), a play sound (e.g., bird, frog, electronic, etc.), and/or a sound volume (low, medium, high, off). As one example, the device may be configured in a frisky play mode for a total play duration of 8 hours with the play duration per hour of 5 minutes, with a bird sound option at a high volume.

While specific control modules, modes, and states have been described herein, it may be understood that these modes are exemplary and not intended to be limiting. All periods of time and threshold times may be random, predetermined, or a combination of random and predetermined.

The embodiment of the device illustrated in FIG. 2 offers the advantage of offering unpredictable motion (e.g., due to ovoid shape) in combination with a significantly higher threshold to damage. Because the embodiment does not include exposed mechanical parts (such as wheels, mechanical arms, axles, etc. common in other toys), household use and use by aggressive animals is less likely to destroy the device or parts of the device that cause motion. In addition, because there are not exposed mechanical parts, the device's motion mechanism cannot pick up common household debris (e.g., dirt, hair, etc.), which is advantageous because accumulation of common household debris cannot destroy the motion mechanism. The mechanism for the device's motion is enclosed in the article, also offering the advantage of disallowing an animal to touch the mechanism.

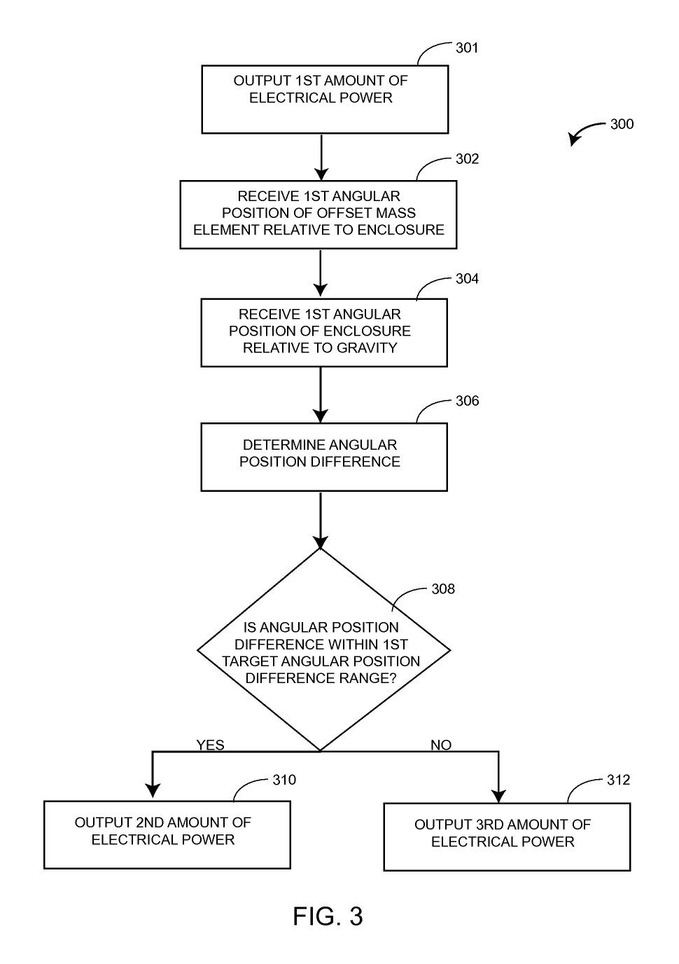

FIG. 3 illustrates a method 300 for controlling a motion of the article 101 disclosed herein. It may be understood that control system 114 may be configured to execute or may be programmed to execute method 300.

The method 300 includes outputting a first amount of electrical power 301. The method 300 further includes receiving a first angular position of an offset mass element relative to the enclosure 302. The method 300 further includes receiving a first angular position of the enclosure relative to a gravity vector 304. The method 300 further includes determining an angular position difference 306. Said determining may include comparing the first angular position of an offset mass element relative to an enclosure to the first angular position of the enclosure relative to the gravity vector.

The method 300 further includes determining if the angular position difference is within a first target angular position difference range (e.g., +85 to +90 degrees, −85 to −95 degrees) 308. If the angular position difference is within the first target angular position difference range, the method 300 includes outputting a second amount of electrical energy 310. Said second amount of electrical energy may be zero energy, in one example, or may be a low amount of energy such that a first target angular position difference is maintained.

If the angular position difference is not within the first target angular position difference range at 308, the method 300 includes outputting a third amount of electrical power 312.

An amount of electrical power for output may be determined using a control function that is dependent on a measured angular position difference. Said control function may be a proportional integral function (e.g., PI controller). For example, if the angular position difference is zero, said control function may dictate the output of a maximum amount of electrical power. In another example, if the angular position difference is +85 degrees, the control function may dictate the output of a minimum amount of electrical power.

It may be appreciated that a method for controlling motion of the article may include a subset of the steps in method 300.

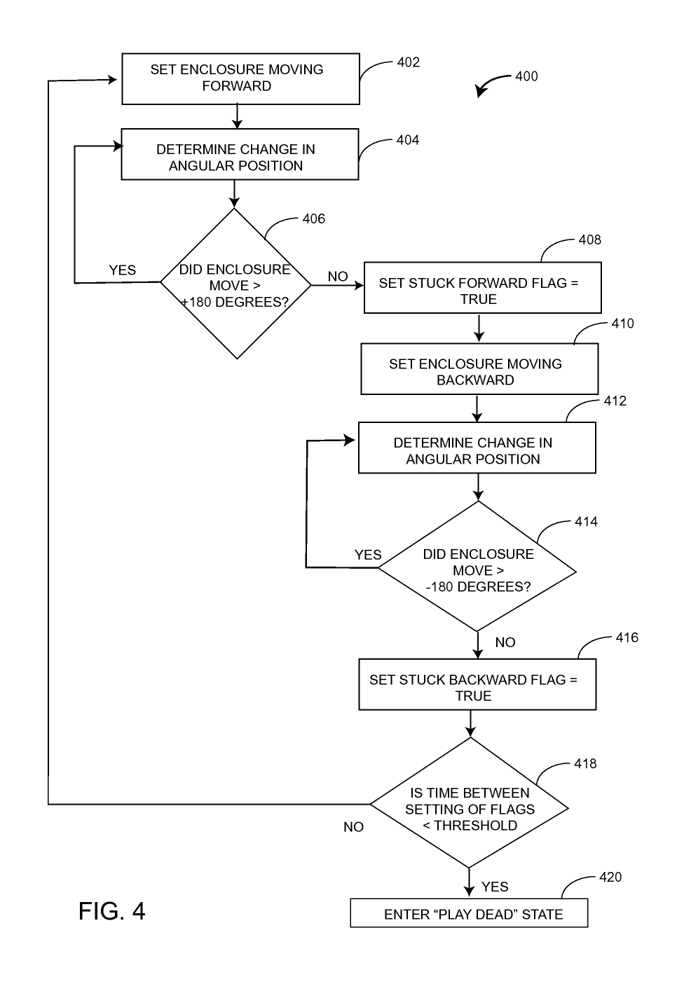

FIG. 4 illustrates an example method 400 for controlling directional motion of a device, such as article 101. At 402, the enclosure is set to move forward. At 404, a change in angular position (e.g., from an initial position to a second position) is determined. For example, this angular position change may be determined by calculating a difference in position based on inputs from one or more accelerometers. At 406, the method 400 includes determining if the enclosure moved more than +180 degrees, which may correspond to a full half-turn of an ovoid or spherical enclosure. If the enclosure moved more than +180 degrees, the method 400 returns to 404 to continue monitoring changes in angular position. If the enclosure did not move more than +180 degrees at 406, a stuck forward flag is set to true at 408 as the device is determined to have been prevented from moving forward more than +180 degrees.

At 410, the enclosure is set to move backward (e.g., in a direction opposite to the direction set at 402) at 410. At 412, a change in angular position is determined. At 414, the method 400 includes determining if the enclosure moved greater than −180 degrees (e.g., more negative). If the enclosure moved greater than −180 degrees (e.g., more negative), the method 400 returns to step 412 to monitor changes in angular position of the enclosure. If the enclosure did not move more than −180 degrees (e.g., more negative) at 414, a stuck backward flag is set to true at 416.

At 418, the method 400 includes determining if a flag time period between setting of the stuck forward flag to true and the setting of the stuck backward flag to true is less than a flag time threshold. If the flag time period is less than the flag time threshold (e.g., 3 seconds), the device enters a “play dead” state at 420. If the flag time period is greater than the flag time threshold at 418, the method 400 returns to 402 and the enclosure is set to move forward. Step 418 offers the advantage of enabling the control system to determine whether the device is truly stuck or trapped or whether the device has simply changed directions and proceeded with motion in an opposite direction for some period of time before hitting an obstacle. Said latter case may occur, for example, if the device is moving in a room with walls.

It may be appreciated that the determination of a change in angular position at 404 and/or at 412 may be carried out at predetermined time intervals. That is, the change in angular position may be carried out by comparing a first angular position at t=0s and a second angular position at t=1s, as just one example. In this way, the determination of an angular position change of the enclosure relative to a gravity vector is constant (e.g., whether ds/dt=−0) enables the determination of whether an obstacle has been reached. In response to determining said changes in angular position, a new amount of electrical power and/or a new direction of electrical power can be output.

The steps of method 300 and method 400 may be performed by the control system disclosed herein or other suitable control system. As previously described, a control system may take the form of a computing device which includes a computer readable medium containing program instructions for varying movement of a pet toy, and wherein one or more processors of the computer system executes the instructions to carry out the steps or operations of the methods.

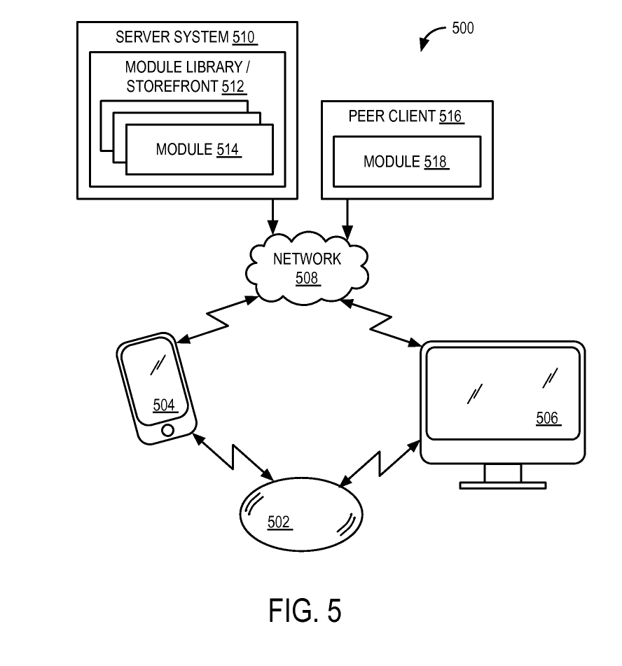

FIG. 5 illustrates a system 500 for communicating with a toy such as article 101 described herein. In this example, the toy 502 is an ovoid shape. A computing device, such as a mobile computing device (e.g., phone, tablet) 504 and/or a non-mobile computing device (e.g., personal computer) 506 may establish a wired or wireless communications link with the toy 502. In one example, a wired communications link may comprise a USB cable or other communications cable. A wireless communications link may be established via Bluetooth, wireless Internet, or any other wireless communications protocol. The mobile computing device 504 and/or non-mobile computing device 506 may communicate with a server system 510 and/or peer client 516 via a network 508. The server system 510 may include a module library or storefront 512 containing one or more modules 514 available for download over the network 508. The peer client may also contain one or more modules 518 for download over the network 508.

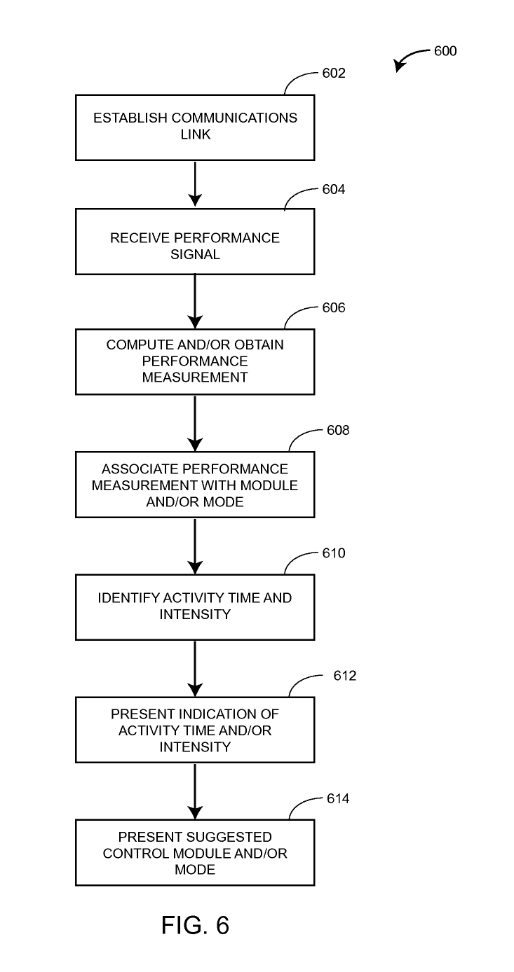

FIG. 6 illustrates a method 600 which can be performed by a system such as system 500. The method 600 includes establishing a wired or wireless communications link 602 with a control system of a device (e.g., a child's toy, a pet's toy), the device performing movement and/or providing aural and/or visual output during a session responsive to detected ambient conditions. The method 600 further includes receiving a performance signal 604, such as a signal corresponding to activity time, activity intensity, etc of a device. The method 600 further includes computing and/or obtaining at least one performance measurement 606 for at least one session from the control system via the wired or wireless communications link. In one example, the performance measurements correspond to activity data (e.g., how active the device was over a period of time, how much interaction the device detected from an animal or child). In another example, the performance measurement information includes performance data regarding whether the device is performing as programmed (e.g., troubleshooting data).

The method 600 further includes associating and/or attributing the at least one performance measurement with one or more control modules and/or one or more modes. The one or more control modules and/or one or more modes may have been implemented by the control system during a session or during a plurality of sessions. For example, activity data may be attributed to a control module (e.g., introductory module, advanced module) containing several play modes. In another example, activity data may be attributed to a specific play mode (e.g., frisky play mode, sneaky play mode, scaredy play mode).

The method 600 further includes, at 610, identifying for each control module of the one or more control modules and/or for each play mode of the one or more play modes, based on the performance measurement associated with the control module(s) and/or play mode(s), (1) an activity time period during the session for that control module and/or (2) an activity intensity during the session for that control module. The activity time period may include a filtered activity time excluding non-activity portions of the session. The activity time period may exclude a portion of time that the device is active without external input (e.g., when the device is active but there is no interaction from the environment, child, and/or pet).

The method 600 further includes presenting an indication of the activity time period and/or the activity intensity for each control module and/or play mode at 612. Said presenting may include presenting via an output device of the computing system (e.g., a graphical display on the device, a graphical display on a computing device coupled to the device).

At 614, the method 600 further includes presenting a recommended control module and/or operation mode based on a comparison of activity time period and/or activity intensity among each control module and/or play mode implemented by the control system during the session. The recommended control module and/or operation mode may or may not include a control module and/or operation mode not yet implemented by the control system. In a case where the recommended control module includes a control module not yet implemented by the control system, the recommended control module may be available for download from a server system by a computing system over a wide area network responsive to a user input, and may be made available for subsequent installation onto the control system via the wired or wireless communications link.

A device, particularly a pet toy, operated with the method 600 is able to stimulate and engage a child or pet in ways that current toys cannot. Because the toy may be reconfigurable (e.g., by manual operation, by auto-download of recommended modules), the toy is able to stimulate the child or pet on an ongoing basis, over a plurality of play sessions. Manual operation may include a process whereby a caretaker downloads new firmware that enables new modes and/or new features that can be accessed. Manual operation may also include manual adjustment of a type of play mode and/or manual adjustment of a setting within a play mode or across play modes (e.g., total play duration, play duration per hour, type of sound, variance of sounds). Play modes and/or settings may also be auto-configurable and changed without input from the caretaker operator. In some cases, the mode and/or setting is automatically changed based on an activity time period associated with a given mode or setting and/or an activity intensity associated with a given mode or setting.

It may be appreciated that the method 600 can be performed over a plurality of sessions, where the entire method is repeated over each session, or where one or more steps of the method is carried out during different sessions.

It may be further appreciated that the method 600 may be carried out by a computing system contained within the device, where the presenting of the indication of an activity time or intensity includes presenting on a coupled display. In another example, the computing system may be wholly or partially separate from the device. For example, a personal computer, mobile device, and/or cloud server may perform some or all of the steps of method 600.

It may be appreciated that the article and devices disclosed herein may also be used to clean a surface. For example, a surface material of the device may be configured to adhere to dirt, dust, or particles, and the surface material may then be cleaned or replaced for future use. In one example, a static or sticky surface material may be used. In this case, the device can be used to clean a surface, such as a floor in a home.

It may be appreciated that the article disclosed herein may also include a cover and/or accessories. For example, a pet toy could include a fur or soft cover and/or eyes to further entice and stimulate the pet. A child toy may include a cover and/or accessories such as crinkly fabric or surface materials suitable for teething to stimulate the child.

Although some above example embodiments have been described for use with a toy, such as a pet toy, it should be appreciated that the methods and systems can be applied to various other types of articles and applications.

It may also be appreciated that, for all exemplary methods disclosed herein, a subset of the steps may be carried out in any order and in no way is the totality and/or order of the included steps intended to be limiting.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An article, comprising:
an enclosure defining a three-dimensional body having an ovoid or spherical shape;
an electric motor disposed within the enclosure, the electric motor including a motor body held in place by the enclosure and a drive shaft;
an offset mass element disposed within the enclosure and mechanically coupled with the drive shaft of the electric motor;
an angular position sensor disposed within the enclosure to measure an angular position of the offset mass element relative to the enclosure;
an accelerometer sensor disposed within the enclosure to measure an angular position of the enclosure relative to a gravity vector; and
a control system disposed within the enclosure, the control system configured to:
receive measurements of the angular position of the offset mass element relative to the enclosure from the angular position sensor;
receive measurements of the angular position of the enclosure relative to the gravity vector;
vary electrical power supplied to the electric motor to drive the drive shaft based, at least in part, on the measurements of angular position of the offset mass element and the angular position of the enclosure to generate rolling motion of the enclosure relative to a surface upon which the enclosure rests.

2. The article of claim 1, wherein the control system is further configured to:
compare the angular position of the offset mass element to the angular position of the enclosure to obtain an angular position difference; and
vary the electrical power supplied to the electric motor responsive to the angular position difference.

3. The article of claim 2, wherein the control system is further configured to:
vary the electrical power supplied to the electric motor responsive to the angular position difference to maintain a target angular position difference.

4. The article of claim 3, wherein the target angular position difference is a first angular position difference that corresponds to rolling motion of the enclosure relative to the surface in a first direction; and
wherein the control system is further configured to vary the electrical power supplied to the electric motor responsive to a second angular position difference to maintain the second target angular position difference;
wherein the second angular position difference corresponds to rolling motion of the enclosure relative to the surface in a second direction opposite the first direction.

5. The article of claim 1, wherein the control system is configured to vary electrical power including adjusting a speed of the electric motor drive shaft responsive to detecting a change in a velocity of the enclosure.

6. The article of claim 1, further comprising:
a drivetrain mechanically coupling the drive shaft of the electric motor with the offset mass element.

7. The article of claim 1, wherein the offset mass element is comprised of a brass material.

8. The article of claim 6, wherein the drivetrain comprises one or more gears and at least one pin coupling said one or more gears to the offset mass element, and wherein the offset mass element is press-fit to the at least one pin.

9. The article of claim 1, wherein the offset mass element is coupled to a magnetic element, and wherein the angular position sensor includes a Hall effect sensor configured to measure the angular position of the offset mass element relative to the electric motor based on interaction with the magnetic element.

10. The article of claim 1, further comprising one or more ambient condition sensors to detect light, sound, and/or touch.

11. The article of claim 1, wherein the control system is configured to vary a position of the offset mass element to produce a linear motion of the enclosure.

12. A method for operating a pet toy, comprising:
outputting electrical power to an electric motor to drive a drive shaft;
receiving a measurement of an angular position of an offset mass element from an angular position sensor;
receiving a measurement of an angular position of an enclosure relative to a gravity vector; and
changing an amount of electrical power output to the electric motor based on, at least in part, the measurement of the angular position of the offset mass element and the measurement of the angular position of the enclosure to generate a rolling motion of the enclosure relative to a surface upon which the enclosure rests.

13. A method performed by a computing system, the method comprising:
establishing a wired or wireless communications link with a control system of a device, the device performing movement and/or providing aural and/or visual output during a session responsive to detected ambient conditions;
obtaining performance measurement information for the session from the control system via the wired or wireless communications link;
associating the performance measurement information with one or more control modules implemented by the control system during the session;
identifying for each control module of the one or more control modules, based on the performance measurement information associated with that control module, (1) an activity time period during the session for that control module and/or (2) an activity intensity during the session for that control module; and
presenting an indication of the activity time period and/or the activity intensity for each control module via an output device of the computing system.

14. The method of claim 13, further comprising:
presenting a recommended control module based on a comparison of activity time period and/or activity intensity among each control module implemented by the control system during the session.

15. The method of claim 13, wherein each control module contains one or more play modes, and wherein the associating includes associating the performance measurement information with each of the one or more play modes.

16. The method of claim 14, wherein the recommended control module includes a control module not yet implemented by the control system.

17. The method of claim 16, further comprising offering the recommended control module for download from a server system over a wide area network responsive to a user input, for subsequent installation onto the control system via the wired or wireless communications link.

18. The method of claim 13, wherein the method is performed over a plurality of sessions.

19. The method of claim 13, wherein activity time includes a filtered activity time that excludes portions of activity time where interaction from an animal was not detected.

20. The method of claim 13, wherein the device is a pet toy.
